(19) United States
(12) Patent Application Publication
(10) Pub. No.: US 2022/0002119 A1
(43) Pub. Date: Jan. 6, 2022

(54) TOWER CRANE HAVING IMPROVED SAFETY

(71) Applicant: Boosup UM, Anyang-si, Gyeonggi-do (KR)

(72) Inventor: Boosup UM, Anyang-si, Gyeonggi-do (KR)

(21) Appl. No.: 17/289,717

(22) PCT Filed: Oct. 29, 2018
(86) PCT No.: PCT/KR2018/012949

§ 371 Date: May 21, 2021

(30) Foreign Application Priority Data
Oct. 29, 2018 (KR) 10-2018-0129796

(51) Int. Cl. B66C 23/26; B66C 23/88; B66C 23/76; E04G 21/04

(52) U.S. Cl. CPC B66C 23/26; B66C 23/88; B66C 23/52; E04G 21/0427; B66C 23/76

(57) ABSTRACT

A tower crane includes: a jib provided to extend or retract along the lengthwise direction; a cathead provided to extend or retract in the vertical direction; and a movable balance weight installed under a counter jib to be slidable in the horizontal direction, outwardly moved to be farther away from a mast when the jib is unfolded to have an increased length, and moved toward the mast when the jib retracts to have a decreased length, so that the center of gravity of the tower crane is adjusted according to the length of the jib and thus the balance is adjusted. Moreover, the tower crane comprises a movement guide part installed between the counter jib and the movable balance weight to guide the movement of the movable balance weight in the horizontal direction.

### TECHNICAL FIELD

The present invention relates to a tower crane, and more particularly, to a tower crane having improved safety which includes a gib and a cat head configured to elongate or contract along a longitudinal direction so as to adjust lengths thereof according to an operating radius of the tower crane or a weight of an object to be recovered, maintains balance by adjusting the center of mass of the tower crane according to a length of the gib and is interlocked when the gib elongates or contracts so as to prevent the tower crane from being overturned, and allows a load acting on an end of the gib to be distributed into and supported by the cat head, a counter gib, an auxiliary gyration portion, and a mast, and in which the cat head and the gib are connected to each other so as to prevent the cat head and the gib from being destroyed when the tower crane is installed or disassembled.

### BACKGROUND ART

Generally, a tower crane is heavy construction equipment used in a construction site such as a building, an open-air storage yard, or the like to recover and deliver large and heavy freight and includes a winding device including a hoist configured to recover and vertically move freight to a certain height and a trolley configured to horizontally move the vertically recovered freight to a certain position.

Also, wire ropes are connected to the hoist and the trolley and drive the hoist and the trolley while wound on or unwound from a winch according to forward or backward rotation of the winch connected to a driving motor.

The tower crane includes a mast vertically installed on the ground, a cantilever-shaped gib mounted on a top end of the mast to gyrate, a counter gib fixed opposite to the gib, an upper tower mounted on a top end of the mast and configured to support the gib and the counter gib, and a suspension for a gib, and the tower crane has one end fixed in front of the gib and the other end fixed to the upper tower to support the gib.

Also, the tower crane includes the hoist configured to vertically recover freight using a wire wound on the winch, the trolley configured to move the vertically recovered freight to a certain position using a wire, a suspension for the counter gib and having one end fixed to the counter gib and the other end fixed to the upper tower so as to support the counter gib, and a counter weight installed on an end of the counter gib and configured to keep balance in movement of the center of mass of the gib according to freight recovery.

Also, a driving motor configured to drive the hoist and a driving portion configured to allow a driving portion such as the winch and the like and the mast to gyrate clockwise or counterclockwise are mounted on the top end of the mast and a heavy counter weight is installed on the end of the counter gib.

This conventional tower crane has a problem in which, since an operating room is mounted on the top end of the mast, when the tower crane is overturned by external environmental factors such as wind pressure, bad weather, or the like or a recovery operation exceeding a preset load, accidents which take a worker's life who operates tens of meters high in the air may occur.

Meanwhile, a tower crane is generally one of cranes configured to lift a heavy object and vertically or horizontally move the heavy object and is used not only in construction sites on land but also in offshore structure construction.

In offshore structure construction, a tower crane may transfer a heavy object while being mounted on a hull of a floating structure. In this case, an excessive load may be concentrated on some points of the hull due to a weight of the tower crane and movement of the heavy object such that a structural damage may occur to the hull.

Also, although it is acutely necessary to maintain an equilibrium of the tower crane to stably drive the tower crane, the hull frequently pitches and rolls on the sea due to influences of wind, waves, tidal currents, and the like such that it is difficult to maintain the equilibrium of the tower crane due to the pitching and rolling of the hull. Also, when the equilibrium of the tower crane is not maintained, a severe accident in which the tower crane is overturned may occur.

### DISCLOSURE

### Technical Problem

The present invention is directed to providing a tower crane having improved safety which includes a gib and a cat head configured to elongate or contract along a longitudinal direction so as to adjust lengths thereof according to an operating radius of the tower crane or a weight of an object to be recovered.

The present invention is also directed to providing a tower crane having an improved safety tower which maintains balance by adjusting the center of mass of the tower crane according to a length of a gib and is interlocked when the gib elongates or contracts so as to prevent the tower crane from being overturned.

The present invention is also directed to providing a tower crane having improved safety, which allows a load acting on an end of a gib to be distributed into and supported by a cat head, a counter gib, an auxiliary gyration portion, and a mast.

The present invention is also directed to providing a tower crane having improved safety, in which a cat head and a gib are connected to each other so as to prevent the cat head and the gib from being destroyed when the tower crane is installed or disassembled.

### Technical Solution

One aspect of the present invention provides a tower crane having improved safety. The tower crane includes masts vertically installed on the ground or on vessel; a counter gib installed on a top surface of a highest mast among the masts; a gyration portion installed between the highest mast and the counter gib and configured to guide the counter gib to gyrate; a gib having one end installed on a gib rotation shaft on the counter gib to vertically rotate and to extend and contract longitudinally so as to adjust an operating radius of the tower crane; a cat head having a bottom end fixed to the counter gib and provided to extend or contract vertically and configured to support a load on the gib and is interlocked when a length of the gib extends or contracts; a roughing cylinder having one end installed on the counter gib and the other end installed on the gib so as to allow the gib to vertically rotate around the gib rotation shaft; a roughing motor installed on the counter gib and configured to support the gib which has pivoted vertically; a roughing tie bar having one end wound on the roughing motor via an end of the cat head and the other end connected to an end of the gib and configured to guide vertical pivoting of the gib with the roughing cylinder and to support the gib which has pivoted vertically; a hoisting motor installed on the counter gib and configured to lift a hook; a hoister wire having one end wound on the hoisting motor via the end of the gib and the other end connected to the hook and configured to lift the hook when the hoisting motor is driven; a first tie bar having one end fixed to the counter gib and the other end fixed to the cat head so as to support the load on the gib in a distributed manner; a fixed balanced weight installed on a top of the counter gib and configured to support the load acting on the gib in a distributed manner; a movable balanced weight installed below the counter gib to be slidably movable in a horizontal direction, moved outward to be farther away from the mast when the gib unfolds so that a length of the gib increases, and moved toward the mast when the gib contracts so that the length of the gib decreases so as to keep balance by adjusting the center of mass of the tower crane according to the length of the gib; a movement guide portion installed between the counter gib and the movable balanced weight and configured to guide the movable balanced weight to be moved horizontally; an auxiliary gyration portion installed on the mast and configured to rotate with the gyration portion interconnected with the gyration portion and support the load acting on the gib in a distributed manner; a second tie bar having one end fixed to the gyration portion and the other end fixed to the auxiliary gyration portion so that a load acting on the counter gib is supported by the mast in a distributed manner through the auxiliary gyration portion; an installing/disassembling safety wire having one end and the other end fastened to the cat head and the gib, respectively, separated from the cat head and the gib when the tower crane is driven, and fastened to the cat head and the gib to prevent accidents when the tower crane is installed or disassembled; wherein lengths of the gib and the cat head extend or contract according to an operating radius, a weight of a heavy object to be recovered, or wind velocity, are adjusted according to work environment, and maximally contract when there is a strong wind so as to minimize an influence of the strong wind, wherein the movable balanced weight is in connection with the gib when the gib extends or contracts and maintains balance to allow center of mass of the tower crane to be adjusted according to the length of the gib, and wherein since a load acting on the end of the gib is distributed into and supported by the cat head, the counter gib, the auxiliary gyration portion, and the mast by the roughing tie bar, the first tie bar, and the second tie bar, accidents are prevented.

The tower crane may further include a vertical transfer pipe connected to a concrete transfer pipe of a pump car and then installed along the mast and the counter gib; a horizontal transfer pipe installed along a longitudinal direction of the gib; a T-shaped pipe configured to connect the vertical transfer pipe to the horizontal transfer pipe; a slip bearing mounted between a top end outer circumference of the vertical transfer pipe and a bottom end inner circumference of the T-shaped pipe and configured to allow the horizontal transfer pipe to gyrate leftward and rightward in connection with leftward and rightward gyration of the gib; a ball joint pipe connected between a top end of the T-shaped pipe and the horizontal transfer pipe and configured to allow the horizontal transfer pipe to tilt upward and downward in connection with upward and downward tilting movement of the gib; a plurality of first distribution transfer pipes configured to diverge and be assembled at preferred positions in a longitudinal section of the vertical transfer pipe; a plurality of second distribution transfer pipes configured to diverge and be assembled at preferred positions in a longitudinal section of the horizontal transfer pipe; and a final discharge pipe connected to end parts of the first distribution transfer pipe and the second distribution transfer pipe by the ball joint pipe.

The movement guide portion may further include a hanger on which a movable balanced weight is mounted and which moves along a side surface of the counter gib and horizontally moves the movable balanced weight; a moving roller coupled to a top end of the hanger and mounted on a top surface of the counter gib and configured to allow the hanger and the movable balanced weight to be horizontally moved; a pinion driving motor installed on the hanger and moved with the movable balanced weight; a pinion coupled to the pinion driving motor and to which rotation power is transmitted from the pinion driving motor; and a rack fixed to the side surface of the counter gib along a movement direction of the movable balanced weight, with which the pinion is engaged, and configured to allow the hanger and the movable balanced weight to be horizontally moved along the rack when the pinion driving motor is driven.

### Advantageous Effects

As described above, according to the present invention, a gib is provided to elongate or contract along a longitudinal direction so as to adjust a length thereof according to an operating radius of the tower crane or a weight of an object to be recovered and a cat head is provided to elongate or contract vertically and in connection with the gib when the length of the gib elongates or contracts so as to support the load on the gib. Accordingly, since the lengths of the gib and the cat head elongate or contract according to an operating radius or a weight of a heavy object to be recovered, the lengths of the gib and the cat head may be adjusted according to work environment. When wind velocity exceeds a wind velocity limit, the lengths thereof may be allowed to minimally contract so as to minimize an influence of a strong wind.

Also, a movable balanced weight is installed below a counter gib to be slidably moved horizontally and moved outward to be farther away from a mast when the gib spreads out and elongates and moved toward the mast when the gib contracts and is shortened so as to keep balance by adjusting the center of mass of the tower crane according to a length of the gib. Also, a movement guide portion is installed between the counter gib and the movable balanced weight and guides the movable balanced weight to be moved horizontally. Accordingly, in connection with contraction of the gib, the movable balanced weight maintains balance by adjusting the center of mass of the tower crane according to the length of the gib so as to prevent the tower crane from being overturned.

A roughing tie bar according to the present invention has one end wound on a roughing motor via an end of a cat head and the other end connected to an end of the gib and configured to guide upward and downward gyration of the gib with a roughing cylinder and to support the gib which has pivoted upward or downward. A first tie bar has one end fixed to the counter gib and the other end fixed to the cat head and distributes and supports a load acting on the gib. A second tie bar has one end fixed to a gyration portion and the other end fixed to an auxiliary gyration portion and distributes and supports a load acting on the counter gib into masts through the auxiliary gyration portion. As described above, since a load acting on an end of the gib is distributed into and supported by the cat head, the counter gib, the auxiliary gyration portion, and the mast by the roughing tie bar, the first tie bar, and the second tie bar, accidents are prevented.

Also, an installing/disassembling safety wire has one end fastened to the cat head and the other end fastened to the gib, separated from the cat head and the gib when the tower crane is driven, and fastened to the cat head and the gib when the tower crane is installed or disassembled. Accordingly, since the cat head and the gib are connected to each other by the installing/disassembling safety wire, it is possible for the cat head or the gib to be prevented to some degree from being destroyed when the tower crane is installed or disassembled so as to prevent accidents.

In the present invention, since the gib and the cat head are provided to have adjustable lengths and the movable balanced weight is provided to have a position horizontally adjustable according to a vertical angle change of the gib, an operating radius is changed or a weight of a heavy object to be recovered is changed, the lengths of the gib and the cat head are adjusted, and the movable balanced weight is moved so as to keep the center of mass of the tower crane so that accidents are prevented. Also, when wind velocity exceeds a reference value, the lengths of the gib and the cat head may be minimized so as to prevent an overturn accident caused by a strong wind.

### DESCRIPTION OF DRAWINGS

FIG. 1 is a schematic front view illustrating a state in which a tower crane having improved safety according to the present invention is installed on the ground.

FIG. 2 is a schematic side view illustrating a movement guide portion according to the present invention.

FIG. 3 is a schematic plan view of the movement guide portion of FIG. 2.

FIG. 4 is a schematic front view illustrating another embodiment of the tower crane of FIG. 1.

FIG. 5 is a schematic front view illustrating a state in which the tower crane having improved safety according to the present invention is installed on a vessel.

FIG. 6 is a schematic front view illustrating another embodiment of the tower crane of FIG. 5.

FIG. 7 is a schematic front view illustrating a state in which a concrete shipping system is installed on the tower crane having improved safety according to the present invention.

### MODES OF THE INVENTION

In order to allow the present invention to be appropriately understood, exemplary embodiments of the present invention will be described with reference to the attached drawings. A variety of modifications of the present invention may be made and the scope of the present invention should not be construed as being limited to the embodiments described below in detail. The embodiments are provided to more completely explain the present invention to one of ordinary skill in the art. Accordingly, throughout the drawings, shapes and the like of elements may be exaggerated for more distinct description. It should be noted that like members may be shown with like reference numerals in each drawing. A detailed description of well-known functions and components will be omitted when it is deemed to unnecessarily obscure the gist of the present invention.

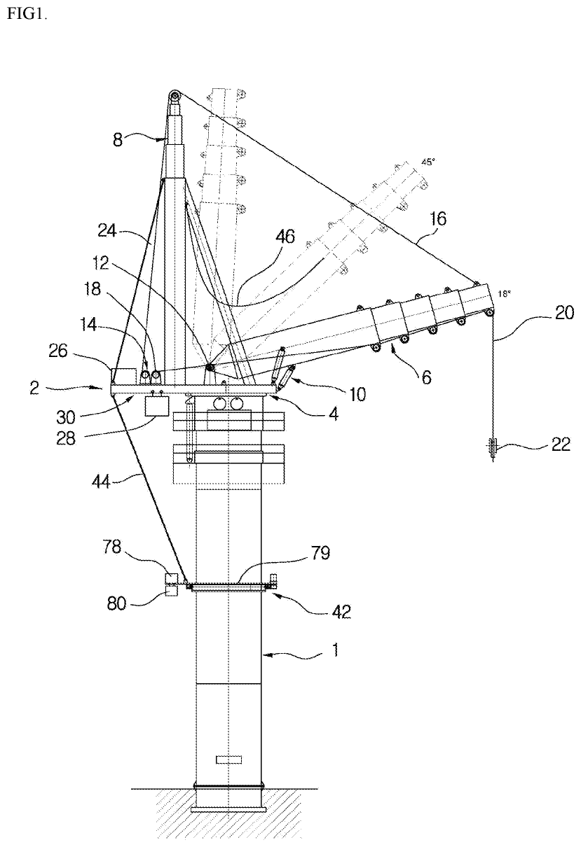

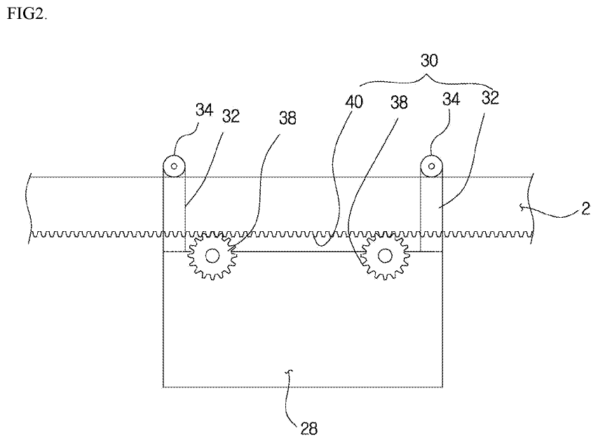

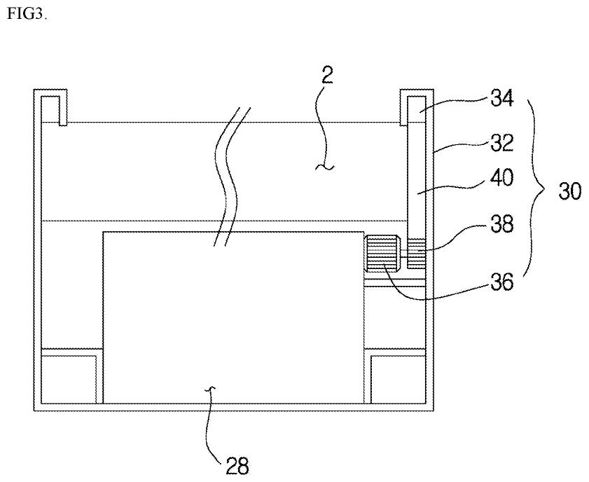

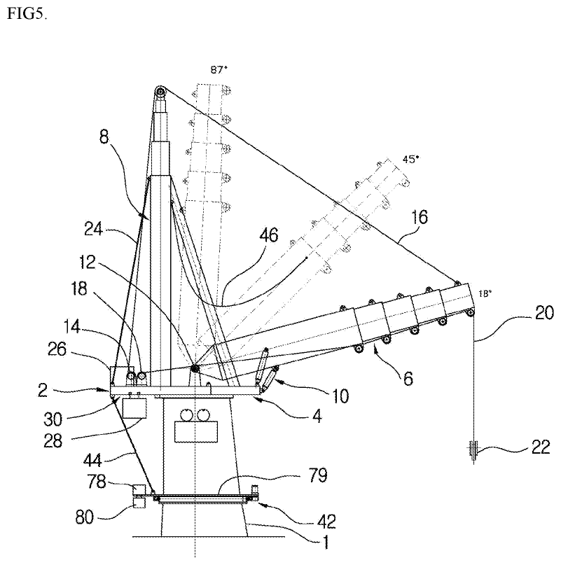

FIG. 1 is a schematic front view illustrating components of a tower crane having improved safety according to the present invention, FIG. 2 is a schematic side view illustrating a movement guide portion according to the present invention, FIG. 3 is a schematic plan view of the movement guide portion of FIG. 2, and FIG. 5 is a schematic front view illustrating a state in which the tower crane having improved safety according to the present invention is installed on a vessel.

The tower crane according to the present invention includes a mast 1, a counter gib 2, a gyration portion 4, a gib 6, a cat head 8, a roughing cylinder 10, a roughing motor 14, a roughing tie bar 16, a hoisting motor 18, a hoister wire 20, a first tie bar 24, a fixed balanced weight 26, a movable balanced weight 28, a movement guide portion 30, an auxiliary gyration portion 42, and a second tie bar 44.

One or more of unit masts 1 are vertically installed on the ground or a vessel according to a height of a tower crane to be installed.

The counter gib 2 is installed on a top surface of a highest mast 1 among the masts 1.

The gyration portion 4 is installed between the highest mast 1 and the counter gib 2 and guides the counter gib 2 to gyrate. The gyration portion 4 may be any component that allows the counter gib 2 to rotate. As an example, the gyration portion 4 may include a ring gear fixedly installed on the mast, a circumscribed gear engaged with the ring gear, and a gyration motor connected to the circumscribed gear and installed on the counter gib 2 to transmit rotation power to the circumscribed gear. In the gyration portion 4, when the gyration motor is driven, the circumscribed gear rotates along a circumference of the ring gear and rotates the counter gib 2.

The gib 6 has one end installed on a gib rotation shaft 12 on the counter gib 2 to vertically rotate and to elongate and contract longitudinally so as to adjust an operating radius of the tower crane.

The gib 6 is a telescoping type gib 6 having a multistage tubular rod to form a long-stroke gib 6.

Accordingly, the gib 6 according to the present invention may vertically pivot about the gib rotation shaft 12 on the counter gib 2 and be provided to horizontally rotated with the counter gib 2 and to elongate or contract along a longitudinal direction of the gib 6 when the gyration portion 4 is driven.

The respective unit gibs 6 of telescoping type gib 6 may have a quadrangular, circular, or diamond-shaped cross section.

A hydraulic method, a chain method, and a rack gear method may be applied to an expansion and contraction structure of the above telescoping type gib 6, and any structures that can fold or unfold the multistage unit gibs 6 along a longitudinal direction thereof may be applied.

The cat head 8 has a bottom end fixed to the counter gib 2 and provided to elongate or contract vertically and supports a load on the gib 6 and is interlocked when a length of the gib 6 elongates or contracts.

The cat head 8 is a telescoping type cat head 8 having a multistage tubular rod to form a long-stroke cat head 8.

Accordingly, the cat head 8 according to the present invention is configured to horizontally rotate with the counter gib 2 and elongates or contracts along a longitudinal direction of the cat head 8 when the gyration portion 4 is driven.

The respective unit cat heads 8 of the telescoping type cat head 8 may have a quadrangular, circular, or diamond-shaped cross section.

A hydraulic method, a chain method, and a rack gear method may be applied to an expansion and contraction structure of the above telescoping type cat head 8, and any structures that can fold or unfold the multistage unit cat heads 8 along a longitudinal direction thereof may be applied.

The roughing cylinder 10 has one end installed on the counter gib 2 and the other end installed on the gib 6 so as to allow the gib 6 to vertically rotate around the gib rotation shaft 12.

One or two roughing cylinders 10 may be installed according to a weight or length of the gib 6.

When the gib 6 is not long or heavy, only one roughing cylinder 10 may be installed between the counter gib 2 and the gib 6. When the gib 6 is long or heavy, two roughing cylinders 10 may be installed between the counter gib 2 and the gib 6.

The roughing motor 14 is installed on the counter gib 2 and supports the gib 6 which has pivoted vertically.

The roughing tie bar 16 has one end wound on the roughing motor 14 via an end of the cat head 8 and the other end connected to an end of the gib 6, guides vertical pivoting of the gib 6 with the roughing cylinder 10, and supports the gib 6 which has pivoted vertically.

The hoisting motor 18 is installed on the counter gib 2 and lifts a hook 22.

The hoister wire 20 has one end wound on the hoisting motor 18 via the end of the gib 6 and the other end connected to the hook 22 and lifts the hook 22 when the hoisting motor 18 is driven.

The first tie bar 24 has one end fixed to the counter gib 2 and the other end fixed to the cat head 8 so as to support a load on the gib 6 in a distributed manner.

The fixed balanced weight 26 is installed on a top of the counter gib 2 and supports the load acting on the gib 6 in a distributed manner.

The movable balanced weight 28 is installed below the counter gib 2 to be slidably movable in a horizontal direction, is moved outward to be farther away from the mast 1 when the gib 6 unfolds so that a length of the gib 6 increases, and is moved toward the mast 1 when the gib 6 contracts so that the length of the gib 6 decreases so as to keep balance by adjusting the center of mass of the tower crane according to the length of the gib 6.

The movement guide portion 30 is installed between the counter gib 2 and the movable balanced weight 28 and guides the movable balanced weight 28 to be moved horizontally.

The movement guide portion 30 includes a hanger 32 on which the movable balanced weight 28 is mounted and which is moved along a side surface of the counter gib 2 and moves the movable balanced weight 28 horizontally, a moving roller 34 coupled to a top end of the hanger 32 and mounted on a top surface of the counter gib 2 to allow the hanger 32 and the movable balanced weight 28 to be moved horizontally, a pinion driving motor 36 installed on the hanger 32 and moved with the movable balanced weight 28, a pinion 38 coupled to the pinion driving motor 36 and to which rotation power is transmitted from the pinion driving motor 36, and a rack 40 fixed to the side surface of the counter gib 2 along a movement direction of the movable balanced weight 28, with which the pinion 38 is engaged, and which allows the hanger 32 and the movable balanced weight 28 to be moved when the pinion driving motor 36 is driven.

Meanwhile, the movement guide portion 30 may have a structure including the rack 40 and the pinion 38 but may be a hydraulic type or a wire type.

In the case of a hydraulic type movement guide portion 30, when a piston load of a cylinder moves forward or backward, the movable balanced weight 28 may be installed to be horizontally moved along a rail. In the case of a wire type movement guide portion 30, when a wire connected to the movable balanced weight 28 is pulled in one direction or in an opposite direction by rotating the motor, the movable balanced weight 28 may be installed to be moved along a rail.

The auxiliary gyration portion 42 is installed on the mast 1, rotates with the gyration portion 4 in connection with the gyration portion 4, and supports the load acting on the gib 6 in a distributed manner.

The auxiliary gyration portion 42 is installed on the mast 1 and connected to a rotating plate 79 to guide the rotating plate 79 with the counter gib 2 when the counter gib 2 gyrates. The auxiliary gyration portion 42 may be any component that allows the rotating plate 79 to rotate. As an example, the auxiliary gyration portion 42 may include a ring gear fixedly installed on the mast 1, a circumscribed gear engaged with the ring gear, and a gyration motor connected to the circumscribed gear and installed on the rotating plate 79 to transmit rotation power to the circumscribed gear. In the auxiliary gyration portion 42, when the gyration motor is driven, the circumscribed gear rotates along a circumference of the ring gear and rotates the rotating plate 79.

Accordingly, since the rotating plate 79 rotates with the counter gib 2 when the counter gib 2 pivots, the second tie bar is not twisted.

Also, on the rotating plate 79, an auxiliary fixed balanced weight 78 and an auxiliary movable balanced weight 80 may be installed to have the same effect as that of the fixed balanced weight 26 and the movable balanced weight 28.

The auxiliary fixed balanced weight 78 is installed on a top of the counter gib 2 and supports the load acting on the gib 6 in a distributed manner. The auxiliary movable balanced weight 80 is installed below the counter gib 2 to be slidably movable in a horizontal direction, is moved outward to be farther away from the mast 1 when the gib 6 unfolds so that a length of the gib 6 increases, and is moved toward the mast 1 when the gib 6 contracts so that the length of the gib 6 decreases so as to keep balance by adjusting the center of mass of the tower crane according to the length of the gib 6.

Although not shown in the drawing, an auxiliary movement guide portion may be installed between the rotating plate 79 and the auxiliary movable balanced weight 80 to guide the auxiliary movable balanced weight 80 to be horizontally moved. The auxiliary movement guide portion may have the same structure as that of the above-described movement guide portion 30 and may guide the auxiliary movable balanced weight 80 to be in connection with the movable balanced weight 28 when the movable balanced weight 28 moves.

The second tie bar 44 has one end fixed to the gyration portion 4 and the other end fixed to the auxiliary gyration portion 42 so that a load acting on the counter gib 2 is supported by the mast 1 in a distributed manner through the auxiliary gyration portion 42.

An installing/disassembling safety wire 46 has one end and the other end fastened to the cat head 8 and the gib 6, respectively, separated from the cat head 8 and the gib 6 when the tower crane is driven, and fastened to the cat head 8 and the gib 6 to prevent accidents when the tower crane is installed or disassembled.

Lengths of the gib 6 and the cat head 8 elongate or contract according to an operating radius, a weight of a heavy object to be recovered, or wind velocity, are adjusted according to work environment, and maximally contract when there is a strong wind so as to minimize an influence of the strong wind. Also, the movable balanced weight 28 is in connection with the gib 6 when the gib 6 elongates or contracts and maintains balance to allow center of mass of the tower crane to be adjusted according to the length of the gib 6. Since a load acting on the end of the gib 6 is distributed into and supported by the cat head 8, the counter gib 2, the auxiliary gyration portion 42, and the mast 1 by the roughing tie bar 16, the first tie bar 24, and the second tie bar 44, accidents are prevented.

The present invention has the following advantages.

First, according to the present invention, the gib 6 is provided to elongate or contract along a longitudinal direction so as to adjust a length thereof according to an operating radius of the tower crane or a weight of an object to be recovered, and the cat head 8 is provided to elongate or contract vertically and in connection with the gib 6 when the length of the gib 6 elongates or contracts so as to support the load on the gib 6.

Accordingly, since the lengths of the gib 6 and the cat head 8 elongate or contract according to an operating radius or a weight of a heavy object to be recovered, the lengths of the gib 6 and the cat head 8 may be adjusted according to work environment. When wind velocity exceeds a wind velocity limit, the lengths thereof may be allowed to minimally contract so as to minimize an influence of a strong wind.

Second, the movable balanced weight 28 is installed below the counter gib 2 to be slidably movable in a horizontal direction, is moved outward to be farther away from the mast 1 when the gib 6 unfolds so that a length of the gib 6 increases, and is moved toward the mast 1 when the gib 6 contracts so that the length of the gib 6 decreases so as to keep balance by adjusting the center of mass of the tower crane according to the length of the gib 6.

Also, the movement guide portion 30 is installed between the counter gib 2 and the movable balanced weight 28 and guides the movable balanced weight 28 to be moved horizontally.

Accordingly, since the movable balanced weight is in connection with the gib 6 when the gib 6 extends or contracts and maintains balance to allow center of mass of the tower crane to be adjusted according to the length of the gib 6, the tower crane is prevented from being overturned.

Third, the roughing tie bar 16 according to the present invention has one end wound on the roughing motor 14 via an end of the cat head 8 and the other end connected to an end of the gib 6, guides vertical pivoting of the gib 6 with the roughing cylinder 10, and supports the gib 6 which has pivoted vertically. The first tie bar 24 has one end fixed to the counter gib 2 and the other end fixed to the cat head 8 so as to support a load on the gib 6 in a distributed manner. The second tie bar 44 has one end fixed to the gyration portion 4 and the other end fixed to the rotating plate 79 and the auxiliary gyration portion 42 so that a load acting on the counter gib 2 is supported by the mast in a distributed manner through the auxiliary gyration portion 42.

As described above, since a load acting on the end of the gib 6 is distributed into and supported by the cat head 8, the counter gib 2, the rotating plate 79, the auxiliary gyration portion 42, and the mast 1 by the roughing tie bar 16, the first tie bar 24, and the second tie bar 44, accidents are prevented.

Fourth, one end and the other end of an installing/disassembling safety wire 46 are fastened to the cat head 8 and the gib 6, separated from the cat head 8 and the gib 6 when the tower crane is driven, and fastened to the cat head 8 and the gib 6, when the tower crane is installed or disassembled, respectively.

Accordingly, since the cat head 8 and the gib 6 are connected to each other by the installing/disassembling safety wire 46, when the tower crane is installed or disassembled, the cat head 8 or the gib 6 may be prevented to some degree from collapsing and thus accidents may be prevented.

Accordingly, in the present invention, since the gib 6 and the cat head 8 are provided to have adjustable lengths and the movable balanced weight 28 is provided to have a position horizontally adjustable according to a vertical angle change of the gib, an operating radius is changed or a weight of a heavy object to be recovered is changed, the lengths of the gib 6 and the cat head 8 are adjusted and the movable balanced weight 28 is moved so as to adjust the center of mass of the tower crane so that accidents are prevented.

Also, when wind velocity exceeds a reference value, the lengths of the gib 6 and the cat head 8 may be minimized so as to prevent an overturn accident caused by a strong wind.

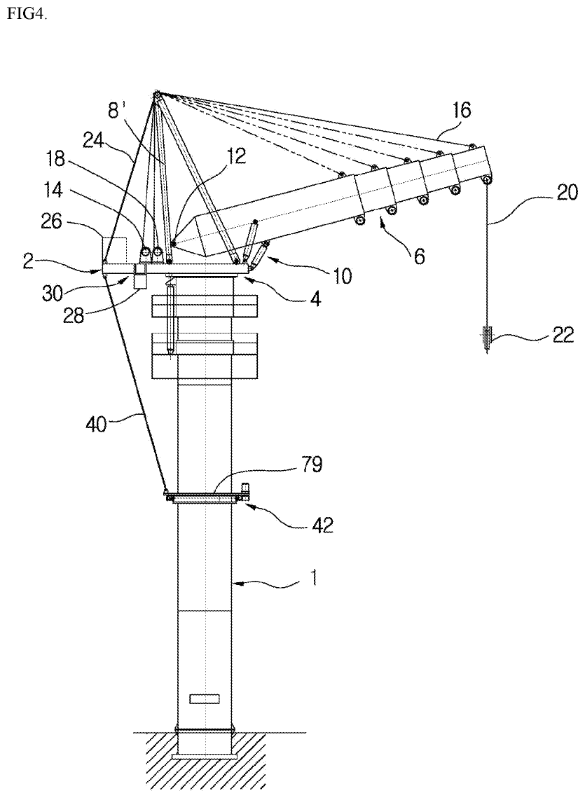

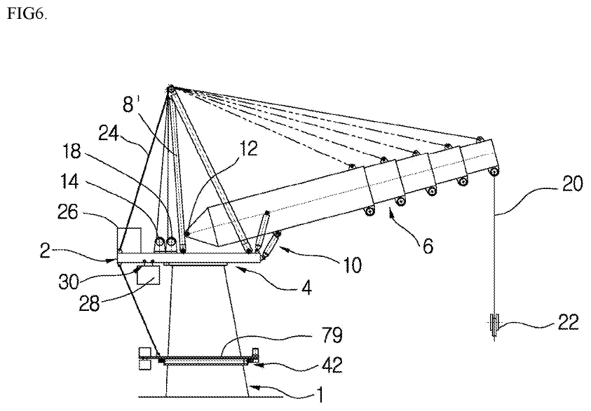

FIG. 4 illustrates another embodiment of a state in which a tower crane having improved safety according to the present invention is installed on the ground, and FIG. 6 illustrates another embodiment of a state in which the tower crane having improved safety according to the present invention is installed on a vessel.

The tower crane having improved safety according to the present invention includes the mast 1, the counter gib 2, the gyration portion 4, the gib 6, the roughing cylinder 10, the roughing motor 14, the roughing tie bar 16, the hoisting motor 18, the hoister wire 20, the first tie bar 24, the fixed balanced weight 26, the movable balanced weight 28, the movement guide portion 30, the auxiliary gyration portion 42, and the second tie bar 44. These components, actions, and effects are equal to those of FIGS. 1 and 5 and a description thereof will be omitted.

The tower crane of FIGS. 4 and 6 may include a cat head 8′ which has one column shape instead of a telescoping shape. Other additional components, actions, and effects are equal to those of FIGS. 1 and 5 and a repetitive description thereof will be omitted.

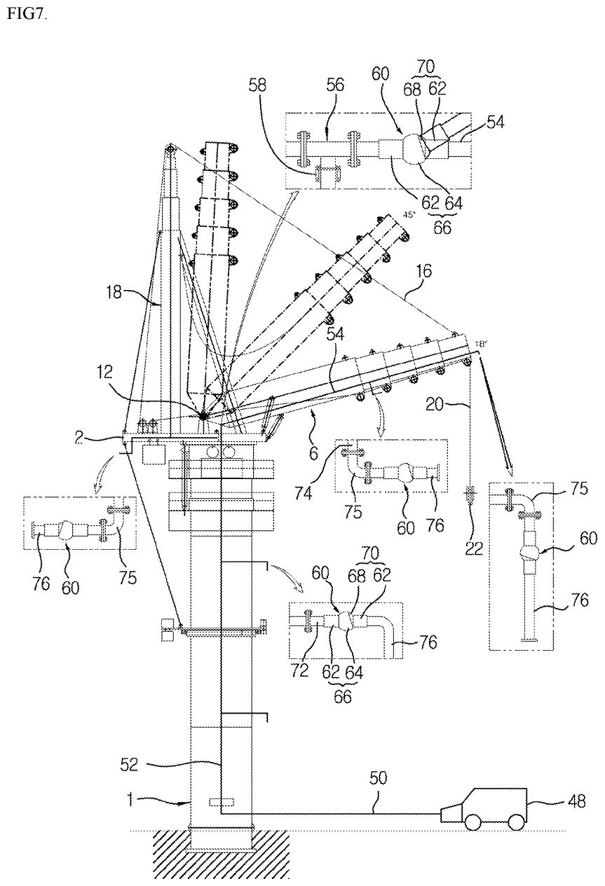

FIG. 7 is a schematic front view illustrating a state in which a concrete shipping system is installed on the tower crane having improved safety according to the present invention. The tower crane having improved safety according to the present invention has a feature in which the concrete shipping system is provided on the tower crane of FIGS. 1 and 5, and other components and effects are equal to those of FIGS. 1 and 5 and thus a description thereof will be omitted.

A vertical transfer pipe 52 is installed on the mast 1 along a longitudinal direction thereof, a horizontal transfer pipe 54 is embedded in the gib 6 along a longitudinal direction thereof, and the vertical transfer pipe 52 is connected to a pump car 48 by a concrete transfer pipe 50.

In order to horizontally pump concrete pumped vertically through the pump car 48, the concrete transfer pipe 50, and the vertical transfer pipe 52 again through the horizontal transfer pipe 54, the vertical transfer pipe 52 and the horizontal transfer pipe 54 are connected to each other by a T-shaped pipe 56.

When the vertical transfer pipe 52 and the horizontal transfer pipe 54 are connected to each other by the T-shaped pipe 56 as described above, since the horizontal transfer pipe 54 is embedded in the gib 6 which performs leftward and rightward gyration and upward and downward tilting movement, it is necessary that the horizontal transfer pipe 54 also is able to perform leftward and rightward gyration and upward and downward tilting movement with the gib 6.

That is, the gib 6 of the tower crane comes not only to hold heavy materials or the like and gyrate to a preferred position but also to tilt to adjust a vertical angle in order to unload the materials and adjust a load position.

Accordingly, it is necessary that the horizontal transfer pipe 54 embedded in the gib 6 is able to perform leftward and rightward gyration and upward and downward tilting movement with the gib 6. Also, since the gib 6 has a telescoping type multistage structure, the horizontal transfer pipe 54 is provided to be adjustable in length to be in connection with a change in length of the gib 6.

To this end, the horizontal transfer pipe 54 may also have a structure in which a plurality of unit connection pipes are coupled to be a telescoping type multistage structure.

Meanwhile, when a top end outer circumference of the vertical transfer pipe 52 is inserted into and mounted on a bottom end inner circumference of the T-shaped pipe 56, a slip bearing 58 is mounted between the top end outer circumference of the vertical transfer pipe 52 and the bottom end inner circumference of the T-shaped pipe 56 so that leftward and rightward gyration of the T-shaped pipe 56 and the horizontal transfer pipe 54 connected to the T-shaped pipe 56 may be secured.

Also, connected parts of the T-shaped pipe 56 and the horizontal transfer pipe 54, that is, a top end of the T-shaped pipe 56 and an inner end of the horizontal transfer pipe 54 are connected by a ball joint pipe 60 so as to allow the horizontal transfer pipe 54 to perform upward and downward tilting movement on the basis of the ball joint pipe 60 when the gib 6 tilts upward or downward so that upward and downward tilting movement of the horizontal transfer pipe 54 may be secured.

Here, the ball joint pipe 60 includes a fixed pipe 66 formed by integrating a connector pipe 62 with a circumscribed hemisphere 64 and a flow pipe 70 formed by integrating the connector pipe 62 with an inscribed hemisphere 68. Here, the inscribed hemisphere 68 of the flow pipe 70 is inserted into and fastened to the circumscribed hemisphere 64 of the fixed pipe 66 to be adjustable in angle upward, downward, leftward, or rightward.

Accordingly, while the inscribed hemisphere 68 of the flow pipe 70 is inserted into and fastened to the circumscribed hemisphere 64 of the fixed pipe 66 to be adjustable in angle upward, downward, leftward, or rightward, the connector pipe 62 of the fixed pipe 66 press fits on and is fastened to a top end of an elbow pipe 75 and the connector pipe 62 of the flow pipe 70 press fits on and is fastened to an inner end of the horizontal transfer pipe 54.

Accordingly, since the flow pipe 70 of the ball joint pipe 60 connected to the horizontal transfer pipe 54 performs upward and downward tilting movement with respect to the fixed pipe 66 when the gib 6 performs upward and downward tilting movement, upward and downward tilting movement of the horizontal transfer pipe 54 may be secured.

Meanwhile, a plurality of first distribution transfer pipes 72 are assembled, while diverging, at preferred positions in a longitudinal section of the vertical transfer pipe 52, and a plurality of second distribution transfer pipes 74 are assembled, while diverging, at preferred positions in a longitudinal direction of the horizontal transfer pipe 54.

The plurality of first distribution transfer pipes 72 and the second distribution transfer pipes 74 are further connected to the vertical transfer pipe 52 and the horizontal transfer pipe 54, respectively, so as to easily distribute the concrete from the pump car 48 into preferred deposition places such as a lower floor, a middle floor, and an upper floor of a high-rise building.

For example, when pumping concrete to a tenth floor and a fifteenth floor of the high-rise building at the same time, the concrete may be pumped to the vertical transfer pipe 52 embedded along the mast 1 of the tower crane from the pump car 48 and then may be pumped and supplied to the tenth floor and the fifteenth floor through the first distribution transfer pipes 72 diverging to the tenth floor and the fifteenth floor from the vertical transfer pipe 52 at the same time.

Preferably, the elbow pipe 75 and the ball joint pipe 60 are continuously connected to end parts of the plurality of first distribution transfer pipes 72 and the plurality of distribution second transfer pipes 74, and a final discharge pipe 76 is connected by the ball joint pipe 60. Here, a valve device is mounted on the final discharge pipe 76 so as to pump the concrete only to a preferred deposition place by opening the valve device only when the concrete is discharged.

That is, when pumping concrete to the tenth floor and the fifteenth floor of the high-rise building at the same time, only the valve devices of the first distribution transfer pipes 72 or the final discharge pipes 76 which diverge from the vertical transfer pipe 52 to the tenth floor and the fifteenth floor are opened and other valve devices of the first distribution transfer pipes 72 or the final discharge pipes 76 are closed so as to pump and supply the concrete only to the tenth floor and the fifteenth floor of the high-rise building at the same time.

Also, when concrete is deposited on the same floor having a large area of the high-rise building, since working efficiency may be increased and working time may be reduced by pumping the concrete to one area and another area of the same floor at the same time, to this end, the concrete may be transferred from the vertical transfer pipe 52 to the horizontal transfer pipe 54 embedded in the gib 6 of the tower crane and then may be pumped and supplied to the one area and the other area of the same floor at the same time through the second distribution transfer pipes 74 diverging from the horizontal transfer pipe 54.

Meanwhile, a pipe further extends from a top end of the vertical transfer pipe 52 toward a counter gib 2 mounted opposite the gib 6 of the tower crane, and the final discharge pipe 76 is connected to an end part thereof by the elbow pipe 75 and the ball joint pipe 60 so as to pump and supply concrete to an area opposite to one area of the same floor through an extension pipe.

Here, the final discharge pipe 76 is connected to the end parts of the first distribution transfer pipes 72 and the second distribution transfer pipe 74 and an end part of the extension pipe by the ball joint pipe 60. Here, the above-described ball joint pipe 60 including the fixed pipe 66 formed by integrating the connector pipe 62 with the circumscribed hemisphere 64 and the flow pipe 70 formed by integrating the connector pipe 62 with the inscribed hemisphere 68 may be used without change.

A reason of connecting the final discharge pipe 150 to end parts of first and second distribution transfer pipes 110 and 120 and an end part of a horizontal extension pipe 124 by a ball joint pipe 140 as described above is to allow a worker to adjust a final discharge direction of concrete.

In more detail, concrete is discharged into a preferred deposition place through the final discharge pipe 76. Here, when the worker holds the final discharge pipe 76 toward a variety of directions so as not to continuously discharge the concrete in the same direction, a discharge direction of the final discharge pipe 76 is easily adjustable by joint movement of the ball joint pipe 60.

Meanwhile, the vertical transfer pipe 52 and the horizontal transfer pipe 54 may be flange joint fastened to the first distribution transfer pipe 72 and the second distribution transfer pipe 74, respectively, to maintain a strong fastening force therebetween.

Meanwhile, a corrosion-protective cover layer may be applied to a surface of the gib rotation shaft 12 to prevent a corrosion phenomenon of a metal surface. Covering materials of the corrosion-protective cover layer may include 20 weight % of mercaptotriazole, 15 weight % of petroleum sulfonates, 10 weight % of mercaptobenzothiazole, 15 weight % of hafnium, 10 weight % of molybdenum sulfide (MoS₂), and 30 weight % of aluminum oxide and may have a coating thickness of 8 μm.

Mercaptotriazole, petroleum sulfonates, and mercaptobenzothiazole perform functions of preventing corrosion, preventing discoloration, and the like.

Hafnium is a corrosion-resistant transition metal element and performs a function of providing a high waterproofing property, corrosion resistance, and the like.

Molybdenum sulfide performs a function of providing a stick-slip property, lubricating property, and the like to a surface of a coating film.

Aluminum oxide is added to provide fire resistance, chemical stability, and the like.

Proportions of components and a coating thickness are numerically limited as described above because an optimal corrosion protective effect is shown with the proportions as a result of analyzing, by the inventor, through several tests.

Also, a pollution/contamination prevention cover layer including a pollution/contamination prevention composite to be applied may be applied to the surface of the gib 6 in order to effectively achieve prevention and removal of pollution/contamination materials.

The pollution/contamination prevention composite to be applied includes alkylated polyglucoside and aminoalkyl slo-betaine at a mole ratio of 1:0.01 to 1:2, and total content of alkylated polyglucoside and aminoalkyl slo-betaine is 1 to 10 weight % with respect to a total aqueous solution.

Since the mole ratio between alkylated polyglucoside and aminoalkyl slo-betaine may be 1:0.01 to 1:2, when the mole ratio deviates from the scope, an application property of materials is degraded or moisture adsorption of the surface after application increases such that a cover film is removed.

Since the alkylated polyglucoside and aminoalkyl slo-betaine may be 1 to 10 weight % in the total composite solution, the application property of the materials is degraded when less than 1 weight % and crystal precipitation caused by an increase in thickness of the application film easily occurs when more than 10 weight %.

Meanwhile, as a method of applying the pollution/contamination prevention materials to be applied on the gib 6, application may be performed using a spraying method. Also, a thickness of the final cover film on the gib 6 may be 500˜2000 Å, and more particularly, may be 1000˜2000 Å. When the thickness of the cover film is less than 500 Å, degradation is caused in high-temperature heat treatment. When the thickness exceeds 2000 Å, crystal precipitation on the application surface easily occurs.

Also, the pollution/contamination prevention materials to be applied may be manufactured by adding 0.1 moles of alkylated polyglucoside and 0.05 moles of aminoalkyl slo-betaine to 1000 ml of distilled water and then agitating the same.

Also, a perimeter of the installing/disassembling safety wire 46 may be coated with an aromatic material mixed with a functional oil so as to have effects of sterilizing the installing/disassembling safety wire 46 and relaxing stress of the worker.

The aromatic material may be mixed with the functional oil. As a mixing ratio, 3 to 5 weight % of the functional oil may be mixed with 95 to 97 weight % of the aromatic material. The functional oil includes 50 weight % of Acacia dealbata oil and 50 weight % of Valeriana fauriei oil.

Here, 3 to 5 weight % of the functional oil may be mixed with the aromatic material. When a mixing ratio of the functional oil is less than 3 weight %, an effect thereof is insignificant. When a mixing ratio of the functional oil exceeds 3 to 5 weight %, a function thereof is not significantly improved while manufacturing costs thereof are greatly increased.

Acacia dealbata oil includes palmic aldehyde, enanthic acid, and the like as major chemical components thereof and has a good scent and sterilization, antidepressant, and stress relaxation effects.

Valeriana fauriei oil includes bornyl acetate, pinene, and the like as major chemical components thereof and performs functions of lowering blood pressure and calming and relaxing so as to have excellent effects in anxiety relief, stress relaxation, and the like.

Since the installing/disassembling safety wire 46 is coated with the functional oil, the installing/disassembling safety wire 46 may be sterilized as well as assisting in fatigue recovery of the worker.

Also, since a rubber packing (not shown) is inserted into a connection part between the horizontal transfer pipe 54 and the vertical transfer pipe 52, 60 weight % of rubber, 33 to 36 weight % of carbon black, 2 to 5 weight % of an antioxidant, and 1 to 3 weight % of sulfur that is a catalyst are mixed at a material content ratio of packing.

Carbon black is added to increase wear resistance. Here, when a content thereof added is less than 33 weight %, elasticity and wear resistance are reduced. When a content thereof exceeds 36 weight %, since a content of rubber that is a major component is relatively less such that elasticity may decrease, 33 to 36 weight % of carbon black is mixed.

As an antioxidant, 2 to 5 weight % of 3C(N-PHENYL-N′-ISOPROPYL-P-PHENYLENEDIAMINE) or RD(POLYMERIZED 2,2,4-RIMETHYL-1,2-DIHYDROQUINOLINE) is selected and added. When less than 2 weight %, a product is easily oxidized. When too much is added and a content exceeds 5 weight %, since a content of rubber that is a major component is relatively reduced such that elasticity may decrease and a cost of an antioxidant is high, 2 to 5 weight % is adequate.

1 to 3 weight % of sulfur that is a catalyst is mixed. Since less than 1 weight % of sulfur has an insignificant vulcanization effect in a heating process in molding, 1 weight % or more is added. When exceeding 3 weight %, since the content of rubber that is a major component is relatively less such that elasticity may decrease, 1 to 3 weight % is adequate.

Accordingly, since the present invention is reinforced with a synthetic rubber having elasticity in a variety of directions such that elasticity, attraction, and stiffness increase, life of packing increases.

Also, a discoloration portion which varies in color according to a temperature may be applied to an outer surface of the pinion driving motor 36. In the discoloration portion, since two or more temperature-discoloration materials which vary in color at a certain temperature or higher are applied to a case surface of the pinion driving motor 36 and separated into two or more sections according to a temperature change, a stepwise temperature change may be determined and a protection layer for preventing the discoloration portion from being damaged is applied to the discoloration portion.

Here, the discoloration portion may be formed by applying temperature discoloration materials having discoloration temperatures of 40° C. or higher and 60° C. or higher. The discoloration portion varies in color according to a temperature of a case of the pinion driving motor 36 to sense a temperature change of paint.

The discoloration portion may be formed by applying temperature discoloration materials which vary in color at a certain temperature or higher to the case surface of the pinion driving motor 36. Also, the temperature discoloration materials generally include a microcapsule structure of 1 to 10 μm and may show color and transparent color due to a coupling and separation phenomenon according to temperatures of an electron donor and an electron acceptor in a microcapsule.

Also, the temperature discoloration materials may quickly vary in color and may have a variety of discoloration temperatures such as 40° C., 60° C., 70° C., 80° C., and the like, and such discoloration temperatures may be easily adjusted using a variety of methods. As the temperature discoloration materials, a variety of types of temperature discoloration materials according to principles such as molecular rearrangement of an organic compound, spatial rearrangement of an atom group, and the like may be used.

To this end, the discoloration portion may be formed by two or more temperature discoloration materials having different discoloration temperatures to be separated into two or more sections according to a temperature change. This temperature discoloration layer may be formed of a temperature discoloration material having a relatively low discoloration temperature and a temperature discoloration material having a relatively high discoloration temperature, and more particularly, may be formed of temperature discoloration materials having discoloration temperatures of 40° C. or higher and 60° C. or higher.

Accordingly, since a temperature change of the pinion driving motor 36 may be checked stepwise, a temperature change of paint may be sensed so as to operate the pinion driving motor 36 in an optimal state and to prevent the pinion driving motor 36 from being damaged by overheating.

Also, the protection layer may be applied to the discoloration portion to prevent the discoloration portion from being damaged by external impact and may be formed using transparent paint having an insulating effect in consideration of easily checking whether the discoloration portion varies in color as well as hot-short temperature discoloration materials.

The above-described embodiments of the tower crane according to the present invention are merely examples, and it is apparent to one of ordinary skill in the art that a variety of modifications and other equivalent embodiments may be made. Therefore, it may be well construed that the present invention is not limited to the forms stated in the above detailed description. Accordingly, the technical scope of the present invention should be determined by the technical concept of the following claims. Also, it should be construed that the present invention includes all modifications, equivalents, and substitutes within the range of the concept of the present invention defined by the following claims.

1. A tower crane having improved safety, comprising:
masts (1) vertically installed on the ground or on a vessel;
a counter gib (2) installed on a top surface of a highest mast (1) among the masts (1);
a gyration portion (4) installed between the highest mast (1) and the counter gib (2) and configured to guide the counter gib (2) to gyrate;
A gib (6) having one end installed on a gib rotation shaft (12) on the counter gib (2) to vertically rotate and to extend and contract longitudinally so as to adjust an operating radius of the tower crane;
a cat head (8) having a bottom end fixed to the counter gib (2) and provided to extend or contract vertically and configured to support a load on the gib (6) and is interlocked when a length of the gib (6) extends or contracts;
a roughing cylinder (10) having one end installed on the counter gib (2) and the other end installed on the gib (6) so as to allow the gib (6) to vertically rotate around the gib rotation shaft (12);
a roughing motor (14) installed on the counter gib (2) and configured to support the gib (6) which has pivoted vertically;
a roughing tie bar (16) having one end wound on the roughing motor (14) via an end of the cat head (8) and the other end connected to an end of the gib (6) and configured to guide vertical pivoting of the gib (6) with the roughing cylinder (10) and to support the gib (6) which has pivoted vertically;
a hoisting motor (18) installed on the counter gib (2) and configured to lift a hook (22);
a hoister wire (20) having one end wound on the hoisting motor (18) via the end of the gib (6) and the other end connected to the hook (22) and configured to lift the hook (22) when the hoisting motor (18) is driven;
a first tie bar (24) having one end fixed to the counter gib (2) and the other end fixed to the cat head (8) so as to support the load on the gib (6) in a distributed manner;
a fixed balanced weight (26) installed on a top of the counter gib (2) and configured to support the load acting on the gib (6) in a distributed manner;
a movable balanced weight (28) installed below the counter gib (2) to be slidably movable in a horizontal direction, moved outward to be farther away from the mast (1) when the gib (6) unfolds so that a length of the gib (6) increases, and moved toward the mast (1) when the gib (6) contracts so that the length of the gib (6) decreases so as to keep balance by adjusting the center of mass of the tower crane according to the length of the gib (6);
a movement guide portion (30) installed between the counter gib (2) and the movable balanced weight (28) and configured to guide the movable balanced weight (28) to be moved horizontally;
an auxiliary gyration portion (42) installed on the mast (1) and configured to rotate with the gyration portion (4) in connection with the gyration portion (4) and support the load acting on the gib (6) in a distributed manner;
a second tie bar (44) having one end fixed to the gyration portion (4) and the other end fixed to the auxiliary gyration portion (42) so that a load acting on the counter gib (2) is supported by the mast (1) in a distributed manner through the auxiliary gyration portion (42);
an installing/disassembling safety wire (46) having one end and the other end fastened to the cat head (8) and the gib (6), respectively, separated from the cat head (8) and the gib (6) when the tower crane is driven, and fastened to the cat head (8) and the gib (6) to prevent accidents when the tower crane is installed or disassembled,
wherein lengths of the gib (6) and the cat head (8) extend or contract according to an operating radius, a weight of a heavy object to be recovered, or wind velocity, are adjusted according to work environment, and maximally contract when there is a strong wind so as to minimize an influence of the strong wind,
wherein the movable balanced weight (28) is in connection with the gib (6) when the gib (6) extends or contracts and maintains balance to allow center of mass of the tower crane to be adjusted according to the length of the gib (6), and
wherein since a load acting on the end of the gib (6) is distributed into and supported by the cat head (8), the counter gib (2), the auxiliary gyration portion (42), and the mast (1) by the roughing tie bar (16), the first tie bar (24), and the second tie bar (44), accidents are prevented.

2. The tower crane of claim 1, wherein the movement guide portion (30) comprises:
a hanger (32) on which a movable balanced weight (28) is mounted and which moves along a side surface of the counter gib (2) and horizontally moves the movable balanced weight (28);
a moving roller (34) coupled to a top end of the hanger (32) and mounted on a top surface of the counter gib (2) and configured to allow the hanger (32) and the movable balanced weight (28) to be horizontally moved;
a pinion driving motor (36) installed on the hanger (32) and moved with the movable balanced weight (28);
a pinion (38) coupled to the pinion driving motor (36) and to which rotation power is transmitted from the pinion driving motor (36); and
a rack (40) fixed to the side surface of the counter gib (2) along a movement direction of the movable balanced weight (28), with which the pinion (38) is engaged, and configured to allow the hanger (32) and the movable balanced weight (28) to be horizontally moved along the rack (40) when the pinion driving motor (36) is driven.

3. The tower crane of claim 1, further comprising:
a vertical transfer pipe (52) connected to a concrete transfer pipe (50) of a pump car (48) and then installed along the mast (1);
a horizontal transfer pipe (54) installed along a longitudinal direction of the gib (6);
a T-shaped pipe (56) configured to connect the vertical transfer pipe (52) to the horizontal transfer pipe (54);
a slip bearing (58) mounted between a top end circumference of the vertical transfer pipe (52) and a bottom end inner circumference of the T-shaped pipe (56) and configured to allow the horizontal transfer pipe (54) to gyrate leftward and rightward in connection with leftward and rightward gyration of the gib (6);
a ball joint pipe (60) connected between a top end of the T-shaped pipe (56) and the horizontal transfer pipe (54) and configured to allow the horizontal transfer pipe (54) to tilt upward and downward in connection with upward and downward tilting movement of the gib (6);
a plurality of first distribution transfer pipes (72) configured to diverge and be assembled at preferred positions in a longitudinal section of the vertical transfer pipe (52);
a plurality of second distribution transfer pipes (74) configured to diverge and be assembled at preferred positions in a longitudinal section of the horizontal transfer pipe (54); and
a final discharge pipe (76) connected to end parts of the first distribution transfer pipe (72) and the second distribution transfer pipe (74) by the ball joint pipe (60),
wherein a ball joint pipe (140) comprises a fixed pipe (143) formed by integrating a connector pipe (141) with a circumscribed hemisphere (142) and a flow pipe (145) formed by integrating the connector pipe (141) with an inscribed hemisphere (144), and the inscribed hemisphere (144) of the flow pipe (145) is inserted into and fastened to the circumscribed hemisphere (143) of the fixed pipe (143) to be adjustable in angle upward, downward, leftward, and rightward.
